(19) United States
(12) Patent Application Publication
(10) Pub. No.: US 2006/0120065 A1
(43) Pub. Date: Jun. 8, 2006

(54) Method and apparatus for shaping an image of an object

(75) Inventor: Erik Martinus Marie Manders, Monnickendam (NL)

Correspondence Address: PEACOCK MYERS, P.C., 201 THIRD STREET, N.W., SUITE 1340, ALBUQUERQUE, NM, 87102, US

(73) Assignee: Universiteit van Amsterdam, Amsterdam (NL)

(21) Appl. No.: 11/280,164

(22) Filed: Nov. 16, 2005

Related U.S. Application Data
(63) Continuation of application No. PCT/NL04/00262, filed on Apr. 20, 2004.

(30) Foreign Application Priority Data
May 16, 2003 (NL) 1023440

(51) Int. Cl. G09F 13/04

(52) U.S. Cl. 362/97

(57) ABSTRACT

The invention relates to a method for forming an image of an object, entailing the illumination of the object, and the detection of light from an area in which the object is located and, based on the detected light, the formation of the image, wherein illumination of the object takes place by distinguishing picture elements in an imaging plane or space, wherein portions of the object corresponding to said picture elements are illuminated for a length of time until for each individual picture element a predetermined first threshold value of the detected light output is reached, wherein also for each individual pixel a corresponding exposure time is registered, and wherein subsequently the image is constructed by determining for each individual pixel a calculated light output value, which depends on at least one predetermined illumination parameter.

The invention relates firstly to a method for forming an image of an object, comprising the illumination of the object, and the detection of light from an area in which the object is located and, based on the detected light, the formation of the image, wherein illumination of the object takes place by distinguishing picture elements in an imaging plane or space.

The invention also relates to an apparatus for forming an image of an object, comprising an illumination unit for illuminating the object, and a detector for detecting light from an area in which the object is located, having directing means for selectively directing light from the illumination unit to the object, which illumination unit is controllable and is connected with a switch that is coupled with the detector, which switch controls the illumination unit conditional on the light detected by the detector, which light comes from the object whose illumination is controlled by the directing means, and an imaging device for constructing an image of the object depending on the light detected by the detector.

Such a method and apparatus are known from U.S. Pat. No. B-6,400,502, and may be used in, for example, the microscopy of living cells. In this area of biology it is desirable to gain information with respect to the position of the molecules, their location and the speed with which they move and the interaction between the molecules. A limiting factor when imaging living cells is, however, the photosensitivity of the cell or the molecules therein. Due to this photosensitivity certain photochemical reactions occur that may result in damage, for example, to the DNA structure of the cell. In U.S. Pat. No. B-6,400,502 illumination of the object is reduced or interrupted depending on the motion of a stage on which the object is placed. This provides however a course measure which does not pay regard to the amount of illumination needed to acquire a true and reliable image of every portion of the illuminated object.

For the practical reasons described above, there is a need therefore for a method and apparatus with which the above-mentioned damage, and further damage caused by light may be restricted and with which nevertheless a true and reliable image of the object can be obtained.

The method and apparatus proposed to this end in accordance with the invention, is characterised by one or several of the measures mentioned in the appended claims.

In a first aspect of the invention, the method for forming an image of an object is characterised in that portions of the object corresponding to the above-mentioned picture elements are illuminated for a length of time until for each individual picture element a predetermined first threshold value of the detected light output is reached, wherein also for each individual pixel a corresponding exposure time is registered, and in that subsequently the image is constructed by determining for each individual pixel a calculated light output value, which depends on at least one predetermined illumination parameter. It should be mentioned that this method is also useful outside the field of microscopy.

This makes it possible to illuminate each individual pixel in a controlled manner, with the illumination always being adjusted to the amount necessary for forming a true and satisfactory image. In this way those parts of objects that require only a small amount of illumination are spared an excess of light, while light-weak parts of objects receive an appropriately intensified illumination.

When illuminating a part of an object, it is advisable to determine in a starting phase whether the detected light output during a predetermined length of time exceeds a predetermined second threshold value and, depending on the outcome, to stop or continue the illumination of the portion of the object. This makes it possible to ensure that light-weak objects are not finally exposed to excessive illumination, because if in the allotted period of time the second threshold value is not exceeded, the respective portion of the object is deemed to possess insufficient imaging information to justify a further continuation of the illumination. This portion of the object is then deemed to contain only background information. The illumination to be carried out in accordance with the invention therefore only takes place if the second threshold value is exceeded in the allocated time.

In order to form an image that is a true reproduction of the illuminated object, it is in a further aspect of the invention desirable for the at least one illumination parameter to be selected from the group comprised of the intensity of the illumination, the exposure time and the detected light output.

Incidentally, the construction of the image may conceivably be based on the exposure time only. This can be realised in particular if the intensity of the applied illumination has a constant value and if the predetermined first threshold value is also fixed, so that the illumination is always terminated at this fixed value. In that case the detected light output is the same for each individual portion of the object and the exposure time determines the light output of the illuminated portion of the object.

As already mentioned, the invention is also embodied in an apparatus for forming an image of an object. In accordance with the invention, this apparatus is characterised in that the directing means is arranged for directing light to a selected portion of the object, and that the apparatus possesses a time registration device for registering the length of time the illumination unit is illuminating the portion of the object whose illumination is controlled by the directing means, that the switch controls the illumination unit to change from an on-position to an off-position when a previously determined amount of light has been detected by the detector, and that the imaging device constructs an image of the object based on at least the time registration device.

A simple manner of measuring the amount of light registered by the detector is characterised in that an integrator or summator that feeds the switch is connected with the detector.

For the selective illumination of an imaging area of the detector it is further desirable that, viewed in the optical path, a disk with an aperture be positioned before the detector.

A preferred embodiment of the apparatus according to the invention is characterised in that the directing means and the disk with the aperture are combined in a Nipkov disk.

In order to enhance the precision of the image of the illuminated object to be formed in accordance with the invention, the same is characterised in that the imaging device for constructing an image of the object is further connected with the integrator or summator, which is connected with the detector for registering the accumulated amount of light from the illuminated portion of the object.

It is further desirable for the imaging device to also be connected with position detection means emitting a signal that is indicative for a location or position of the object. This is a convenient manner of forming a three-dimensional image of the illuminated object.

Hereinbelow the invention will be further elucidated by way of the non-limiting exemplary embodiment with reference to the drawing.

In the drawing:

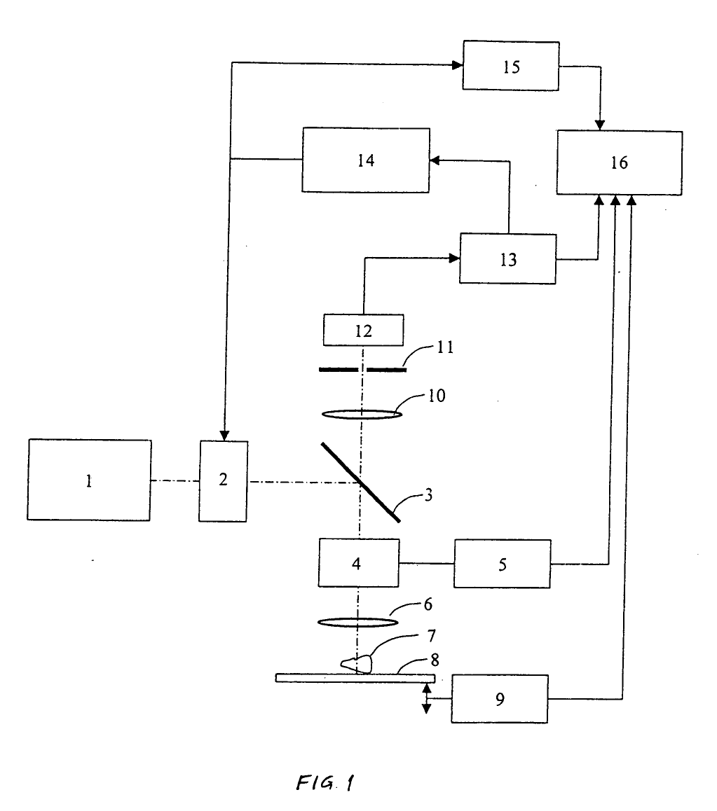

FIG. 1 shows a first embodiment of the apparatus according to the invention, and

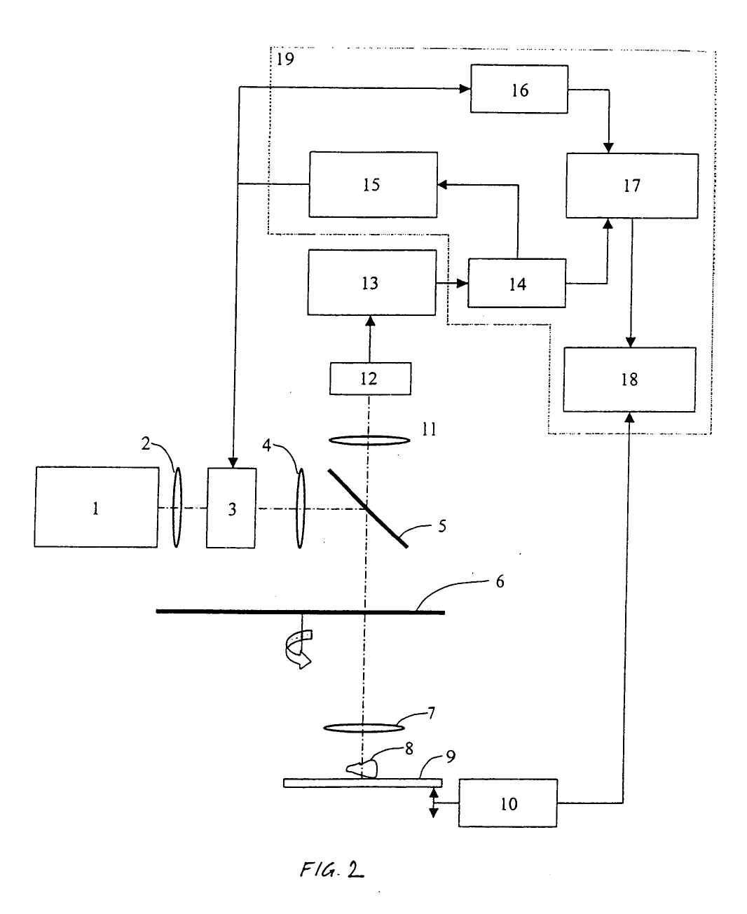

FIG. 2 shows a second embodiment of the apparatus according to the invention.

Referring first to FIG. 1, a schematic illustration is shown of the construction of a microscope embodied in accordance with the invention. This microscope comprises a light source 1 and a modulator 2 for adjusting the light intensity of the light from the light source 1. This light is directed in the direction of a beam splitter 3 and, via a directing means 4 and a lens 6, reaches the object 7 to be illuminated. The reflected or fluorescent light from the object 7 that via lens 6 and the directing means 4 propagates through the beam splitter 3, is conducted via a lens 10 in the direction of detector 12 and in doing so, passes through an aperture provided in a disk 11 that corresponds with the portion of that object illuminated by means of the directing means 4. This aperture allows the illumination of the part of the detector 12, to which a corresponding picture element in the imaging plane or imaging space is coupled.

The detector 12 feeds an integrator or summator 13 that is incorporated in a closed control circuit, which also includes control unit 14 and modulator 2.

The integrator or summator 13 determines how much light has been received by the detector 12 since the commencement of an illumination of a portion of the object 7, and when a predetermined threshold value is reached, the regulator 14 adjusts the position of the modulator 2 such that light from the illumination unit 1 is no longer able to reach the object 7.

The control unit 14 is further connected with a time registration device 15. This time registration device 14 and optionally the integrator or summator 13 feed an imaging device 16 and based thereon, this constructs an image of the object 7. Intelligent use is also made on the one hand of information obtained via signal provider 5 relating to the portion of the object 7 that by means of scanning device 4 is illuminated and further of position information relating to the object 7. This position information is obtained with the aid of signal provider 9 that passes on the position setting of a table on which the object 7 is placed.

With further reference to FIG. 2, a second embodiment of the apparatus according to the invention is shown, in which a Nipkov disk is used.

The apparatus shown in FIG. 2 also comprises an illumination unit 1 wherein after passing a beam splitter 5, light from this illumination unit 1 is via lenses 2 and 4 and a modulator 3 able to pass the Nipkov disk 6, and after passage through a further lens 7 is able to reach the object 8.

The reflected or fluorescent light from the object 8 moves via lens 7 again through the Nipkov disk 6 and after passing the beam splitter 5 and lens 11, reaches this detector 12. With this detector 12 a storage unit 13 may be connected for storing pixel by pixel the light detected by the detector 12. With this storage unit 13 a summator 14 is connected that feeds a control unit 15 and which, together with the modulator 3, forms a closed control circuit for controlling the amount of light from the light source 1.

Advantageously, further connected with the control unit 15 is a time registration unit 16 that can be used for constructing pixel by pixel an image of the object 8 in the imaging device 17. When forming the image of the object, the imaging device 17 may also take account of the amount of light detected per pixel, so as to enhance the precision. This value is available in the summator 14.

A three-dimensional image can be obtained by combining the two-dimensional image from the imaging device 17 with information from signal provider 10 relating to the position of the object 8, in an image processing device 18.

The above described non-limiting exemplary embodiments of the apparatus according to the invention make a method workable in which the illumination necessary for forming an image involving living material causes less damage than is the case with systems and methods of the prior art. Importantly, the illumination of the portions of the object corresponding with the pixels or picture elements to be obtained is controlled in the sense that the illumination applied per pixel, is gauged to the image information detected in reality. When constructing the image, the image is thus eventually obtained by taking into account the illumination performed, respectively the exposure time, and the detected amount of light from the examined object. the exposure time, and the detected amount of light from the examined object.

As will be apparent from the forgoing, the present invention concerns a totally new approach and presents a different principle for forming an image of a living organism than was available in the prior art. Consequently, the protective scope due the invention must not be deemed to be limited to the above exemplary embodiments, but must encompass the spirit of the invention as epitomised in the claims and as can be recognised from the above specification and appended drawing.

1. A method for forming an image of an object, entailing the illumination of the object, and the detection of light from an area in which the object is located and, based on the detected light, the formation of the image, wherein illumination of the object takes place by distinguishing picture elements in an imaging plane or space, wherein portions of the object corresponding to said picture elements are illuminated for a length of time until for each individual picture element a predetermined first threshold value of the detected light output is reached, wherein also for each individual pixel a corresponding exposure time is registered, and wherein subsequently the image is constructed by determining for each individual pixel a calculated light output value, which depends on at least one predetermined illumination parameter.

2. A method according to claim 1, wherein the at least one illumination parameter is selected from the group comprised of the intensity of the illumination, the exposure time and the detected light output.

3. A method according to claim 1 wherein the illumination of the portions of the object corresponding with the individual picture elements is performed for each portion of the object separately.

4. A method according to claim 1 wherein it is determined in a starting phase whether the detected light output during a predetermined length of time exceeds a predetermined second threshold value and, depending on the outcome, to stop or continue the illumination of the portion of the object.

5. An apparatus for forming an image of an object, comprising an illumination unit for illuminating the object, and a detector for detecting light from an area in which the object is located, having directing means for selectively directing light from the illumination unit to the object, which illumination unit is controllable and is connected with a switch that is coupled with the detector, which switch controls the illumination unit conditional on the light detected by the detector, which light comes from the object whose illumination is controlled by the directing means, and an imaging device for constructing an image of the object depending on the light detected by the detector, wherein the directing means is arranged for directing light to a selected portion of the object, wherein same possesses a time registration device for registering the length of time the illumination unit is illuminating the portion of the object whose illumination is controlled by the directing means, and wherein the switch controls the illumination unit to change from an on-position to an off-position when a previously determined amount of light has been detected by the detector, and wherein the imaging device constructs an image of the object based on at least the time registration device.

6. An apparatus according to claim 5, wherein an integrator or summator that feeds the switch is connected with the detector.

7. An apparatus according to claim 5 wherein viewed in the optical path, a disk with an aperture is positioned before the detector for the selective illumination of an imaging area of the detector.

8. An apparatus according to claim 7 wherein the directing means and the disk with the aperture are combined in a Nipkov disk.

9. An apparatus according to claim 6, wherein the imaging device for constructing an image of the object is further connected with the integrator or summator, which is connected with the detector for registering the accumulated amount of light from the illuminated portion of the object.

10. An apparatus according to claim 5, wherein the imaging device is also connected with position detection means emitting a signal that is indicative for a location or position of the object.
